(19) United States
(12) Patent Application Publication
(10) Pub. No.: US 2006/0239772 A1
(43) Pub. Date: Oct. 26, 2006

(54) Connecting structure for connecting automotive interior member and automotive body panel

(75) Inventor: Takeshi Kuroda, Yokohama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: PIOLAX INC., Yokohama-shi (JP)

(21) Appl. No.: 11/406,421

(22) Filed: Apr. 19, 2006

(30) Foreign Application Priority Data
Apr. 20, 2005 (JP) 2005-122096

(51) Int. Cl. B25G 3/18

(52) U.S. Cl. 403/329

(57) ABSTRACT

The connecting structure for connecting an automotive interior member and an automotive body panel is provided with a grommet to be inserted in and engaged with a mounting hole of the automotive body panel, a pin member to be detachably or integrally attached to a mounting seat formed on the interior member, a band connecting the grommet to the mounting seat. One end of the band is connected to the grommet. At the other end of the band, an engaging portion to be slidably engaged with an elongated hole of the mounting seat is provided. The engaging force between the mounting hole of the automotive body panel and the grommet is set to be greater than the engaging force between the grommet and the pin member.

This application claims priority under 35 U.S.C. § 119 to Japanese Patent Application No. 2005-122096 filed on Apr. 20, 2005, the entire disclosure of which is incorporated herein by reference in its entirety.

### BACKGROUND OF THE INVENTION

1. Field of the Invention

The present invention relates to a connecting structure for connecting an automotive interior member and an automotive body panel, more specifically to a connecting structure for connecting, for example, an interior member such as a cover member for covering an automotive air bag and an automotive body panel.

2. Description of Related Art

The following description sets forth the inventor's knowledge of related art and problems therein and should not be construed as an admission of knowledge in the prior art.

Japanese Unexamined Laid-open Patent Publication (Japanese Translation of PCT International Application) No. 2002-519591, for example, discloses a structure that connects a cover member for covering an automotive air bag and an automotive body pane. This structure includes a male member to be attached to an automotive body panel, a female member to be attached to a mounting seat formed on an interior member, and a band for connecting the male member and the female member. The male member has a hook-like leg portion to be engaged with a mounting hole of an automotive body panel at one end and a protruded portion to be detachably inserted into the female member at the other end.

In attaching the cover to the automotive body panel, the male member is first attached to the female member by inserting the protrusion of the male member into the female member while bending the band. Next, the leg portion of the male member is inserted into the mounting hole of the automotive body panel. Thus, the automotive interior member is attached to the automotive body panel via the female member and the male member.

When the air bag mounted between the automotive interior member and the automotive body panel is activated and expanded in accordance with an impact of collision of the automobile, the interior member will be torn off from the automotive body panel. In this case, however, since the interior member is connected to the automotive body panel with the band, the interior member can be prevented from ejecting toward the passenger's space of the automobile to thereby secure the safety of passengers.

The distance between the interior member and the automotive body panel should be adjusted depending on various conditions such as types of vehicles and mounting portions. Accordingly, considering the various conditions, the length of the band is adjusted and the maximum displacement of the interior member at the time of the complete expansion of the band when the air bag is activated is set. However, such band has a male member and a female member at its ends, and therefore various parts different in band length should be prepared depending on various conditions. Unfortunately, this prevents commoditizing of parts, resulting in increased manufacturing costs.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve existing methods and/or apparatuses.

Among other advantages, some embodiments provide a connecting structure for connecting an automotive interior member and an automotive body panel capable of adjusting the maximum displacement of the automotive interior member at the time of the complete expansion of a band connecting the automotive interior member and the automotive panel without changing a length of the band.

Among other advantages, some embodiments provide a connecting structure for connecting an automotive interior member and an automotive body panel capable of commoditizing of parts irrespective of various conditions such as types of vehicles and mounting portions.

According to one aspect of the present invention, a connecting structure for connecting an automotive interior member and an automotive body panel, includes: a grommet to be inserted in and engaged with a mounting hole of the automotive body panel, a pin member to be detachably attached to a mounting seat formed on the interior member, the pin member being configured to be inserted in and engaged with the grommet, and a band for connecting the grommet and the mounting seat.

The band is connected to the grommet at one end thereof and provided with an engaging portion at the other end thereof. The engaging portion is configured to be slidably engaged with an elongated hole formed in the mounting seat.

An engaging force between the mounting hole of the automotive body panel and the grommet is set, for example, to be greater than an engaging force between the grommet and the pin member.

With this structure, for example, the interior member (e.g. a trim cover member) can be attached to the automotive body panel by inserting the grommet into the mounting hole of the automotive body panel in a state in which the engaging portion formed at the other end of the band of the grommet is engaged with the elongated hole of the mounting seat of the interior member and the pin member formed on the mounting seat of the interior member is inserted in and engaged with the grommet.

In cases where an air bag is disposed between the interior member and the automotive body panel, when a strong tearing force is applied to the interior member in accordance with the activation of the air bag due to a collision of an automobile, the pin member will be pulled out of the grommet since the engaging force between the grommet and the mounting hole is larger than the engaging force between the grommet and the pin member. However, since the grommet is connected to the mounting seat via the band, the excessive ejection of the interior member can be restrained by the band, thereby preventing the interior member such as a cover member from hitting the passengers.

Furthermore, depending on the type of automobile, the distance between the automotive body panel and the interior member differs. Therefore, it is necessary to adjust the restriction length by the band. In the invention, however, the maximum displacement amount of the interior member when the band is fully extended can be changed, for example, by changing the length of the elongated hole to be formed in the mounting seat. Thus, it is possible to commoditize the clip constituted by the grommet, the pin member and the band by changing the length of the elongated hole of the mounting seat.

It is preferable that the engaging portion provided at the other end of the band has a columnar portion to be inserted in the elongated hole of the mounting seat, and an inner periphery of an end portion of the elongated hole with which the columnar portion comes into contact at the time of the engagement is formed into an arc-shape.

With this structure, when the ejection of the interior member is restricted by the band at the time of the detachment of the pin member from the grommet due to a strong detaching force applied to the interior member, the columnar portion of the engaging portion is engaged with the arc-shaped upper end portion of the elongated hole of the mounting seat. Accordingly, the band would not be twisted even if it is pulled in any directions, thereby minimizing the chance of breakage of the band due to the widthwise tension applied to the band.

It is also preferable that, in a state in which the interior member is connected to the automotive body panel, an engaging portion between the mounting hole of the automotive body panel and the grommet and an engaging portion between the grommet and the pin member are positioned at a rear side of the automotive body panel.

With this structure, since both the engaging portions are positioned at the rear surface side of the automotive body panel, it becomes possible to further decrease the distance between the automotive body panel and the interior member. Thus, even in cases where the distance between the automotive body panel and the interior member is small, this structure can be applied.

With the connecting structure connecting an automotive interior member and an automotive body panel according to some preferable embodiments, when a strong tearing force is applied to the interior member, the pin member will be pulled out of the grommet since the engaging force between the grommet and the mounting hole is larger than the engaging force between the grommet and the pin member. However, the grommet is connected to the mounting seat via the band, the excessive ejection of the interior member can be restrained by the band. Furthermore, the maximum displacement amount of the interior member when the band is fully extended can be changed by changing the length of the elongated hole to be formed in the mounting seat. Thus, it becomes possible to commoditize the clip constituted by the grommet, the pin member and the band by simply changing the length of the elongated hole of the mounting seat.

According to another aspect of the present invention, a connecting structure for connecting an automotive interior member and an automotive body panel, includes: a grommet to be inserted in and engaged with a mounting hole of the automotive body panel, a pin member integrally attached to a mounting seat formed on the interior member, the pin member being configured to be inserted in and engaged with the grommet, and a band for connecting the grommet and the mounting seat. The band is connected to the grommet at one end thereof and provided with an engaging portion at the other end thereof. The engaging portion is configured to be slidably engaged with an elongated hole formed in the mounting seat. An engaging force between the mounting hole of the automotive body panel and the grommet is set to be greater than an engaging force between the grommet and the pin member.

With this structure, since the pin member is integrally attached to the interior member via the mounting seat, the step of attaching the pin member to the mounting seat can be omitted, thereby improving the attaching workability.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is an exploded perspective view showing a connecting structure for connecting an automotive interior member and an automotive body panel according to one embodiment of the present invention;

FIG. 2 is a perspective view showing the state in which a pin member is attached to a grommet;

FIG. 3 is a perspective view showing the state in which a band attached to the grommet is being attached to a mounting seat;

FIG. 4 is a perspective view showing the state in which the pin member is being attached to the mounting seat;

FIG. 5 is a perspective view showing the state in which the pin member and the grommet are attached to the mounting seat;

FIG. 6 is a cross-sectional view showing the state in which an interior member is attached to an automotive body panel via the grommet and the pin member;

FIG. 7 is a cross-sectional view showing the state in which the pin member is detached from the grommet;

FIG. 8 is a cross-sectional view as seen from the arrow A in FIG. 7;

FIG. 9 is an exploded perspective view showing a connecting structure for connecting an automotive interior member and an automotive body panel according to a second embodiment of the present invention; and

FIG. 10 is a cross-sectional view showing the connecting structure of the second embodiment.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those skilled in the art based on these illustrated embodiments.

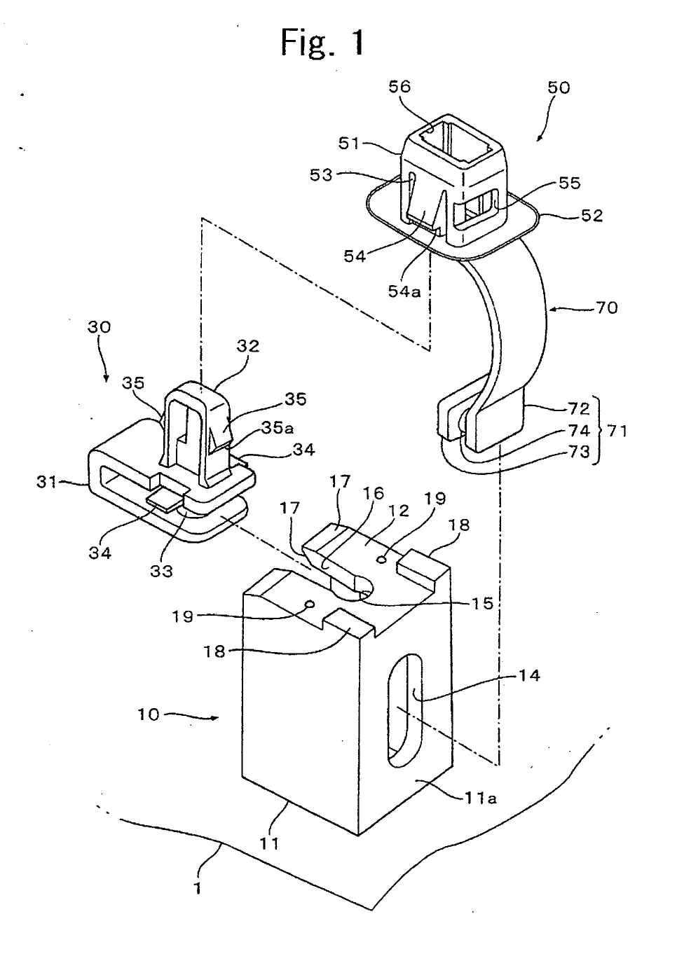

FIGS. 1-8 depict a connecting structure for connecting an automotive interior member and an automotive body panel according to one embodiment of the present invention.

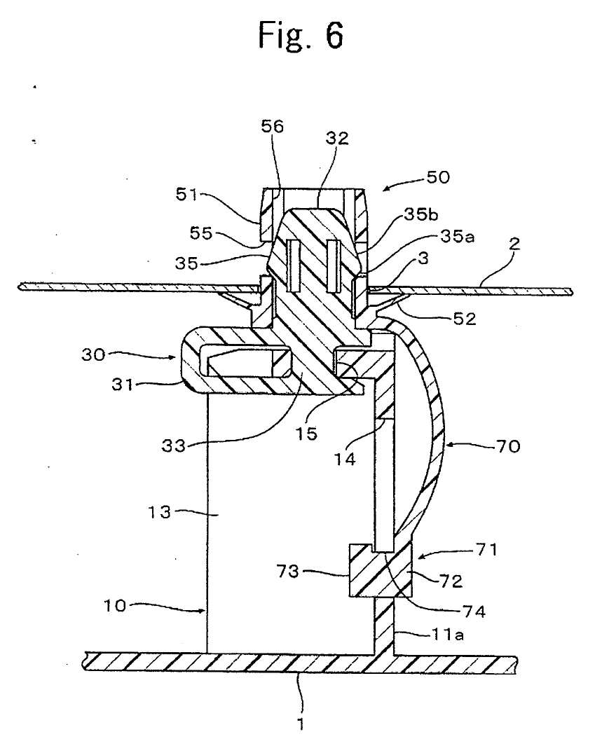

As shown in FIG. 6, the connecting structure for connecting an automotive interior member and an automotive body panel (hereinafter simply referred to as “connecting structure”) is used to attach the interior member 1 such as a trim cover to the automotive body panel 2.

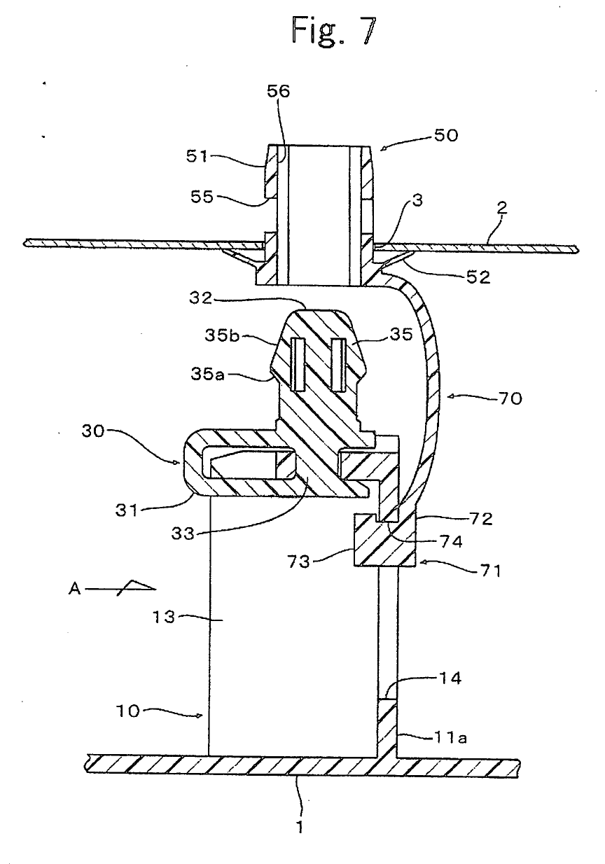

As shown in FIG. 1, a mounting seat 10 is protruded from the interior member 1. This mounting seat 10 includes a frame-like wall 11 of a generally U-shape in cross-section protruded from the rear surface of the interior member 1, a mounting wall 12 covering the opening opened toward the direction perpendicular to the interior member 1, and an opening 13 (see FIGS. 6 and 7) opened toward the direction parallel to the interior member 1.

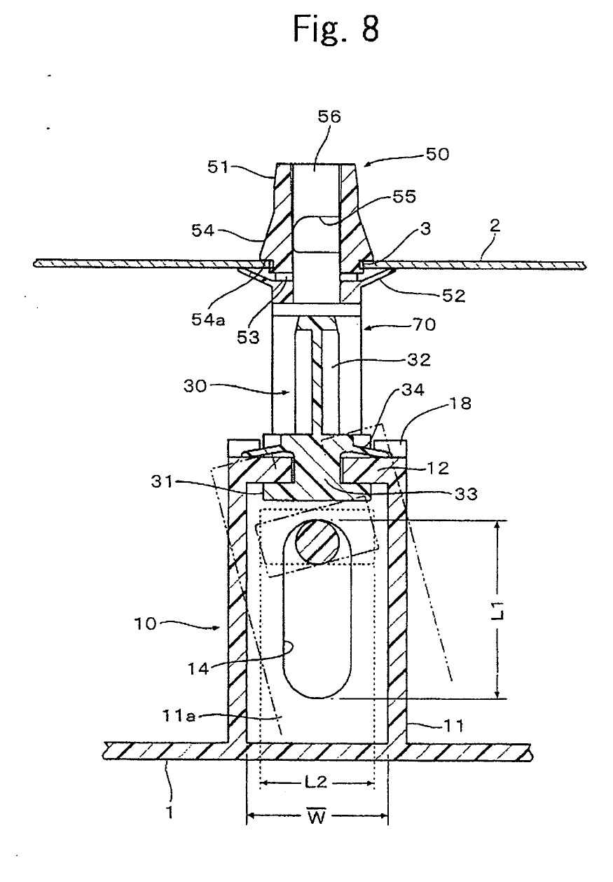

As shown in FIGS. 1 and 8, the frame-like wall 11 has a width W and a depth capable of attaching the basal portion 31 of the pin member 30 which will be detailed. The width W of the frame-like wall 11 is set to be larger than the length L2 of the engaging plate 73 of the engaging portion 71 formed at the end of the band 70 which will be detailed.

In the wall portion 11a of the frame-like wall 11 opposed to the opening 13, an elongated hole 14 extending in a direction perpendicular to the interior member 1 is formed. The inner periphery of each end portion of the elongated hole 14 in the major axis thereof is formed into an arc shape and functions as a portion with which the external periphery of the columnar shaft 74 of the engaging portion 71 of the band 70 comes into contact. The length L1 of the elongated hole 14 along the direction of the major axis is set to be larger than the length L2 of the engaging plate 73 of the engaging portion 71 of the band 70, and the width of the elongated hole 14 along the direction of the minor axis is set to be shorter than the length L2 of the engaging plate 73 but larger than the width of the engaging plate 73 so that the engaging plate 73 can be inserted into the inside of the frame-like wall 11 through the elongated hole 14.

The length L1 of the elongated hole 14 along the direction of the major axis defines the displacement amount of the engaging portion 71 from the state in which the engaging portion 71 is located at the bottom portion of the elongated hole 14 to the state in which the engaging portion 71 is located at the top portion of the elongated hole 14 where the band 70 extends completely, and is determined every type of vehicle. In this embodiment, the elongated hole 14 extends in a direction perpendicular to the interior member 1. The elongated hole 14, however, can be formed so as to extend obliquely or in a curved manner. It is preferable that the elongated hole 14 extends in the moving direction of the interior member 1 with respect to the automotive body panel 2.

At approximately the central portion of the mounting wall 12, an engaging hole 15 for engaging the shaft portion 33 of the pin member 30 in an inserted state is formed so as to fit the shaft portion 33. Furthermore, an insertion slit 16 of a certain width is formed in the mounting wall 12 so as to extend from the end of the opening portion 13 to the engaging hole 15 so that the shaft portion 33 of the pin member 30 can be inserted sideways.

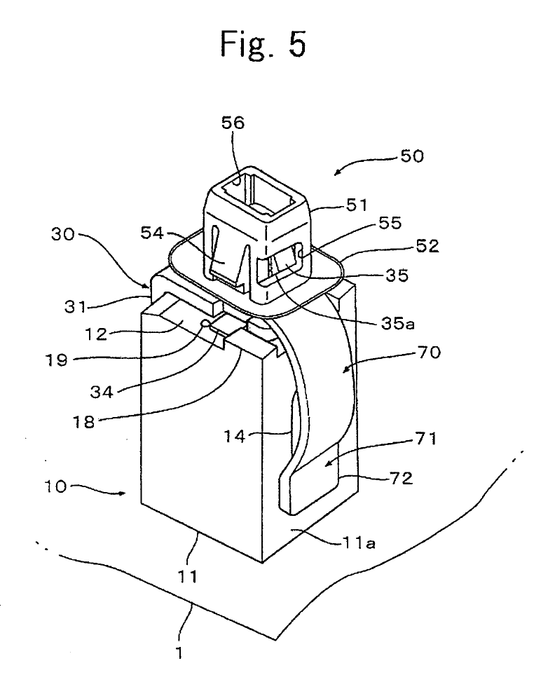

The opening side edge of the mounting wall 12 is formed into a tapered portion 17 decreasing in thickness toward the tip end so that the attaching workability of the pin member 30 can be secured. The mounting wall 12 is provided with a pair of upwardly protruded ribs 18 and 18 at the comers away from the opening portion 13 and a pair of protrusions 19 and 19 away from the ribs 18 and 18 by a certain distance. As shown in FIG. 5, in the state in which the pin member 30 is attached to the mounting seat 10, the tip end of the basal portion 31 of the pin member 30 is located between the ribs 18 and 18 and elastic wings 34 and 34 of the pin member 30, which will be explained later, are located between the corresponding rib 18 and protrusion 19, whereby the pin member 30 is positioned so as not to be rotated.

The pin member 30 to be attached to the mounting seat 10 is formed into a generally U-shape as seen from the side and, includes a basal portion 31 to be inserted in the frame-like wall 11 to be held to the mounting seat 10 in an engaged manner, a protruded portion 32 vertically protruded from one surface of the basal portion 31 so as to be inserted into the tubular portion 51 of the grommet 50 which will be mentioned later, and the shaft portion 33 connecting the opposed inner surfaces of the basal portion 31 to be engaged with the engaging hole 14 of the mounting seat 10.

From both basal sides of the protruded portion 32, a pair of elastic wings 34 and 34 extend sideways. In the state in which the basal portion 31 is attached to the mounting seat 10, the elastic wings 34 are in elastic contact with the upper surface of the mounting wall 12 to thereby prevent the fluctuations of the basal portion 31 as well as the rotation of the pin member 30 as mentioned above.

The protruded portion 32 is formed into a generally U-shape as seen from the side, and is provided with a pair of engaging protrusions 35 and 35. Each engaging protrusion 35 is formed into an angular shape with inclined surfaces 35a and 35b different in inclination angle with respect to the tubular portion 51 (see FIGS. 6 and 7).

In this embodiment, the basal side inclined surface 35a is formed to have an inclination angle steeper than the inclination angle of the tip side inclined surface 35b so as to be engaged with the lower edge portion of the engaging hole 55 of the grommet 50, which will be explained later, to thereby engage the pin member 30 with the grommet 50. The engaging force of the engaging protrusion 35 of the pin member 30 with respect to the engaging hole 55 of the grommet 50 is set to be smaller than the engaging force of the elastic engaging portion 54 of the grommet 50, which will be explained later, with respect to the mounting hole 3 of the automotive body panel 2 so that the pin member 30 can be detached from the grommet 50 at the time of the activation of the air bag.

The grommet 50 to be engaged with the protruded portion 32 of the pin member 30 is formed into a generally rectangular tubular shape, and has the tubular portion 51 to be inserted into the mounting hole 3 of the automotive body panel 2 and an elastic flange 52 extending from the basal periphery of the tubular portion 51 obliquely upward toward the peripheral end.

At the opposed side walls of the tubular portion 51, an elastic engaging portion 54 is formed via a generally U-shaped slit 53, respectively. Each elastic engaging portion 54 can be elastically deformed due to the slit 53, and is formed into a tapered shape gradually increasing in height from the tip end side of the tubular portion 51 toward the basal end side thereof. At the lower end of the elastic engaging portion 54, an engaging stepped portion 54a is formed. This engaging stepped portion 54a is engaged with the rear surface peripheral edge of the mounting hole 3 of the automotive body panel 2 to attach the grommet 50 to the automotive body panel 2. The engaging force of the engaging portion 54 of the grommet 50 with respect to the mounting hole 3 of the automotive body panel 2 is set to be larger than the engaging force of the engaging protrusion 35 of the pin member 30 with respect to the engaging hole 55 of the grommet 50, so that the engaging state of the grommet 50 to the automotive body panel 2 can be maintained assuredly.

In the other opposed side walls of the tubular portion 51, engaging holes 55 and 55 for engaging the engaging protrusions 35 and 35 of the pin member 30 are formed. On each of the inner surfaces of the opposed side walls having the engaging holes 55 of the tubular portion 51, a guide groove 56 wider than the engaging protrusion 35 of the pin member 30 is formed so as to extend in the axial direction of the tubular portion 51. This guide groove 56 enables the insertion of the outwardly protruded engaging protrusion 35 of the pin member 30 while guiding the engaging protrusion 35 at the time of inserting the protruded portion 32 of the pin member 30 into the tubular portion 51 of the grommet 50.

The elastic flange 52 of the tubular portion 51 comes into elastic contact with the periphery of the mounting hole 3 at the time of attaching the grommet 50 to the automotive body panel 2 to restrain of, e.g., the fluctuations of the grommet 50.

The band 70 is a generally belt shaped curved member with one end connected to the outside of the basal end of the tubular portion 51 of the grommet 50. At the other end of the band 70, the engaging portion 71 to be slidably engaged with the elongate hole 14 of the mounting seat 10 is provided. The engaging portion 71 is provided with a base plate 72 formed by outwardly slightly bending the other end portion of the band 70, an engaging plate 73 disposed parallel to the base plate 72 at a certain distance, and a columnar shaft 74 connecting the base plate 72 and the engaging plate 73.

As explained above, the engaging plate 73 is formed to have a size smaller than the elongated hole 14 and a length L2 smaller than the width W of the frame-like wall 11 (see FIG. 8) so as to be rotated about the columnar shaft 74 in the frame-like wall 11. The distance between the base plate 72 and the engaging plate 73 is slightly larger than the thickness of the wall portion 11a of the frame-like wall 11 of the mounting seat 10.

After inserting the engaging plate 73 into the elongated hole 14 so as to locate the columnar shaft 74 at the elongated hole 14, the engaging portion 71 is rotated with respect to the wall portion 11a of the frame-like wall 11. As a result, the engaging portion 71 is engaged with the elongated hole 14 with the wall portion 11a pinched by and between the base plate 72 and the engaging plate 73 in a state in which the engaging potion 71 can be slidably moved along the major axis of the elongate hole 14.

Now, an example of the assembly process of the connecting structure of this embodiment will be explained.

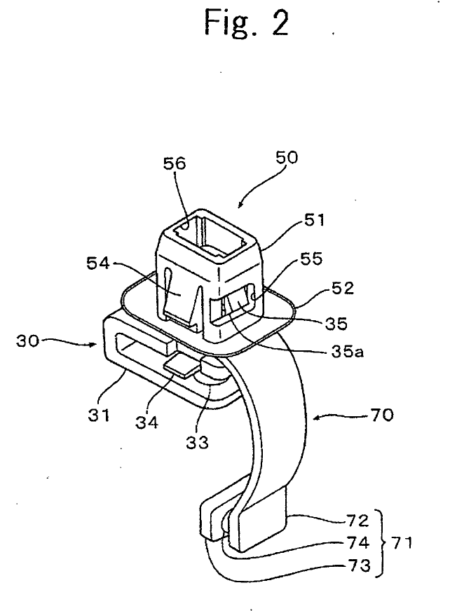

Initially, as shown in FIG. 2, the protruded portion 32, not shown, of the pin member 30 is inserted into the tubular portion 51 of the grommet 50 to engage the inclined surface 35a of the engaging protrusion 35 with the lower edge portion of the engaging hole 55, to thereby attach the pin member 30 to the grommet 50.

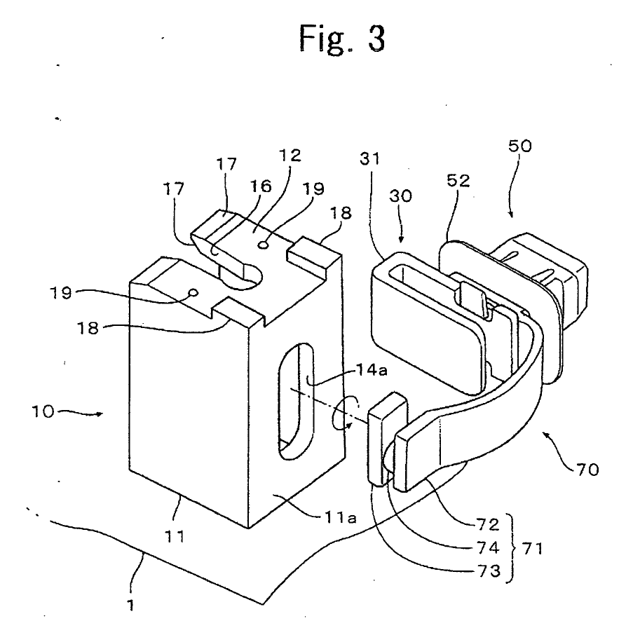

With this state, as shown in FIG. 3, the engaging plate 73 of the engaging portion 71 is inserted into the elongated hole 14 of the mounting seat 10 in an aligned state to be positioned in the frame-like wall 11. Then, by rotating the engaging portion 71 with respect to the wall portion 11a in the direction shown by the arrow in FIG. 3, the engaging portion 71 is slidably attached to the elongated hole 14 of the mounting seat 10.

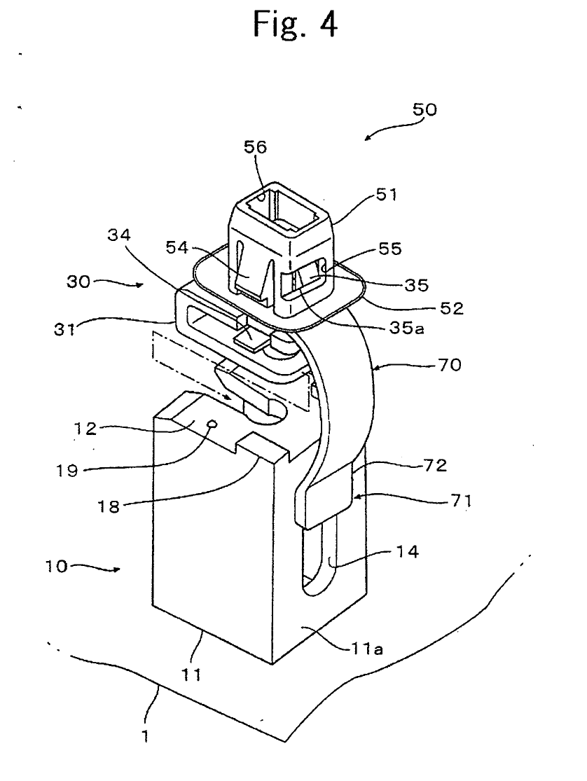

While slightly sliding the engaging portion 71 of the band 70 downward along the elongate hole 14, as shown in FIG. 4, the generally U-shaped basal portion 31 of the pin member 30 is inserted from the opening 13 of the mounting seat 10 so as to pinch the mounting wall 12 (see the arrow in FIG. 4) to position the shaft portion 33 in the engaging hole 15. As a result, as shown in FIG. 5, the pin member 30 is attached to the mounting seat 10. Thus, the pin member 30 and the grommet 50 are attached to the interior member 1 via the mounting seat 10.

At the time of inserting the tubular portion 51 of the grommet 50 into the mounting hole 3 of the automotive body panel 2 from the surface side, the tubular portion 51 gradually protrudes toward the rear surface of the automotive body panel 2 while bending the elastic engaging portions 54 and 54 of the grommet 50 by being pressed by the inner surface of the mounting hole 3. When the engaging stepped portion 54a reaches the mounting hole 3, the elastic engaging portions 54 and 54 are elastically restored. As a result, the engaging stepped portion 54a is engaged with the peripheral edge of the mounting hole 3, whereby the grommet 50 is attached to the automotive body panel 2 (see FIGS. 6 and 8). Thus, the interior member 1 such as a cover member can be attached to the automotive body panel 2 via the pin member 30 and the grommet 50.

Alternatively, the assembly can be performed as follows. That is, initially, the grommet 50 is slidably attached to the elongated hole 14 of the mounting seat 10 via the engaging portion 71 of the band 70. With this state, the pin member 30 is attached to the mounting seat 10. Thereafter, the protruded portion 32 of the pin member 30 is inserted into the tubular portion 51 of the grommet 50 to thereby attach the pin member 30 to the grommet 50. It should be understood that the assembling order is not specifically limited in this invention.

The aforementioned connecting structure can be applied to, for example, an automobile air bag apparatus. In this case, an air bag (not shown) is disposed between the interior member 1 and the automotive body panel 2. When a strong tearing force is applied to the interior member 1 in accordance with the activation of the air bag due to a collision of an automobile, as shown in FIG. 7, the pin member 30 will be pulled out of the grommet 50 since the engaging force between the grommet 50 and the mounting hole 3 is larger than the engaging force between the grommet 50 and the pin member 30. At the same time, the air bag will be inflated from the space between the interior member 1 and the automotive body panel 2 toward the passenger space to secure the safety of the passengers. At this time, although the interior member 1 will also jump out toward the passenger space, since the grommet 50 is connected to the mounting seat 10 via the band 70, the excessive ejection of the interior member 1 can be restrained by the band 70, thereby assuredly preventing the interior member 1 such as a cover member from hitting against the passengers.

Although the pin member 30 is attached to the mounting seat 10 with the shaft portion 33 of the pin member 30 engaged with the engaging hole 15 of the mounting seat 10, when a force in a direction opposite to the opening of the insertion slit 16 of the mounting seat 10 is applied to the interior member 1, the shaft portion 33 of the pin member 30 may be detached from the engaging hole 15 and the insertion slit 16, which in turn may cause detachment of the pin member 30 from the mounting seat 10. Even in such case, in the connecting structure of the present invention, since the interior member 1 is connected to the grommet 50 via the mounting seat 10 and the band 70, the movement of the interior member 1 can be restricted, which in turn can prevent a collision of the interior member 1 against the passengers.

Furthermore, depending on the type of automobile, the distance between the automotive body panel 2 and the interior member 1 differs. Therefore, it is necessary to adjust the restriction length by the band 70. In the invention, however, the maximum displacement amount of the interior member 1 when the band 70 is fully extended can be changed by changing the length L of the elongated hole 14 to be formed in the mounting seat 10. Thus, it becomes possible to commoditize the clip constituted by the grommet 50, the pin member 30 and the band 70 by simply changing the length L of the elongated hole 14 of the interior member 1, resulting in reduced costs.

Furthermore, like the conventional male member previously mentioned, in cases where the male member has protrusions at both sides, i.e., a leg portion to be engaged with an automotive body panel at one side and a protrusion to be detachably inserted in a female member, the thickness in the direction perpendicular to the automotive body panel increases, resulting in bulky structure. To the contrary, however, with the connecting structure according to the present invention, since the protruded portion 32 of the pin member 30 is inserted in the tubular portion 51 to be engaged therein and the elastic engaging portion 54 of the tubular portion 51 is engaged with the mounting hole 3 of the automotive body panel 2, the connecting structure does not take up much space as compared to the aforementioned conventional male member, resulting in compact structure.

In the state in which the grommet 50 and the pin member 30 are attached to the mounting seat 10, the engaging portion 71 of the band 70 is slid along the elongated hole 14 to be positioned at the lower end of the elongated hole 14. Thus, the band 70 does not protrude in the horizontal direction with respect to the interior member 1 since it is not bent, thereby minimizing the interference with other members at the time of installing to the automotive body panel 2, which in turn can improve the installation workability.

Furthermore, when the ejection of the interior member 1 is restricted by the band 70 at the time of the detachment of the pin member 30 from the grommet 50 due to a strong detaching force applied to the interior member 1, the columnar shaft 74 of the engaging portion 71 is engaged with the arc-shaped upper end portion of the elongated hole 14 of the mounting seat 10. Accordingly, since the engaging portion 71 is slid from the lower end of the elongated hole 14 to the upper end thereof in addition to the length of the band 70, the maximum displacement amount can be increased. At that time, as shown in FIG. 8, since the mounting seat 10 is rotated with respect to the engaging portion 71, the band 70 would not be twisted even if it is pulled in any directions, thereby minimizing the chance of breakage of the band 70 due to the widthwise tension applied to the band 70.

Furthermore, in the state in which the interior member 1 is connected to the automotive body panel 2, the mounting hole 3 and the engaging stepped portion 54a which are engaging portions of the mounting hole 3 of the automotive body panel 2 and the grommet 50, and the inclined surface 35a of the engaging protrusion 35 and the lower edge of the engaging hole 55 which are engaging portions of the grommet 50 and the pin member 30, are positioned at the rear side of the automotive body panel 2, respectively. This makes it possible to further decrease the distance between the automotive body panel 2 and the interior member 1. Thus, the connecting structure can be applied to the case in which the distance between the automotive body panel 2 and the interior member 1 is short.

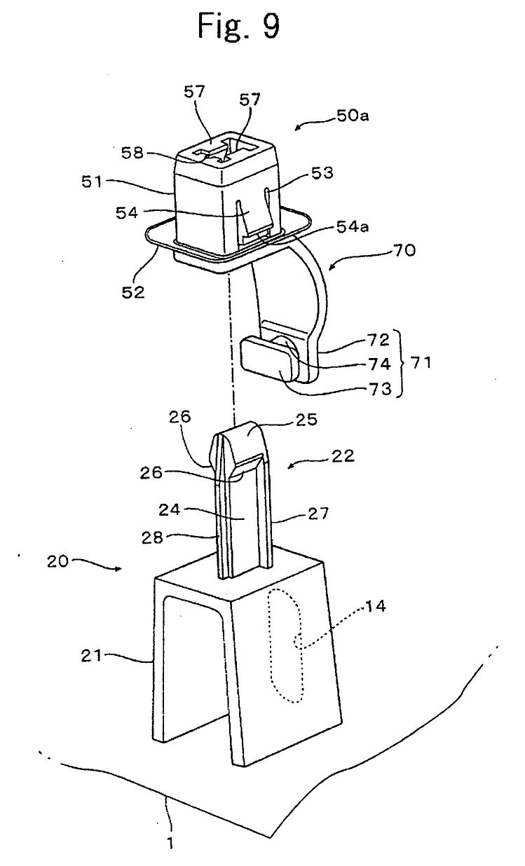

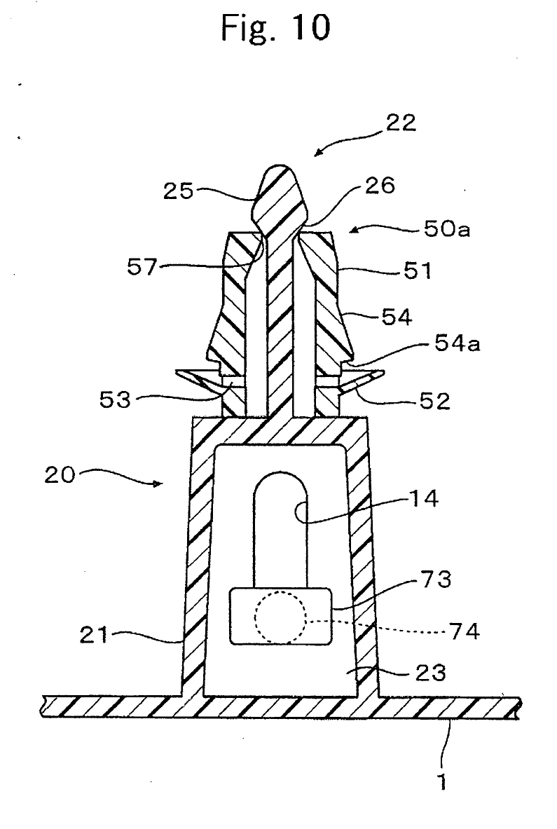

FIGS. 9 and 10 show connecting structure according to another embodiment of the present invention. In the following explanation, the explanation of the portions essentially the same as those of the first embodiment will be omitted by allotting the same reference numerals.

In FIGS. 9 and 10, the pin member and the mounting seat are integrally formed.

Here, pin member 20 includes a frame 21 of a generally U-shape as seen from the side with a closing side wall 23, and a protruded portion 22 upwardly protruded from approximately the center of the upper wall of the frame 21. In the side wall 23 of the frame 21 (see FIG. 10), an elongated hole 14 similar to the elongated hole shown in FIGS. 1-8 is formed.

The protruded portion 22 has a pillar portion 24 and a head portion 25 expanded at the tip end of the pillar portion 24. Between the pillar portion 24 and the head portion 25, a tapered engaging surface 26 extending in the widthwise direction of the pillar portion 24 is formed. From one side of the pillar portion 24, a guide rib 27 is protruded in a direction perpendicular to the width direction of the pillar portion 24. From the other side of the pillar portion 24, a guide rib 28 is protruded in the width direction of the pillar portion 24.

In this grommet 50a, elastic engaging portions 54 and 54 are formed in a pair of opposed side walls of the tubular portion 51 via a generally U-shaped slit 53 respectively in the same manner as in the first embodiment. On the inner surfaces of the side walls to which the elastic engaging portions 54 are formed, a pair of engaging protrusions 57 nad 57 are formed. This engaging protrusion 57 has a tapered shape gradually decreasing in height toward the inside of the tubular portion 51 and constitutes an engaging portion to be engaged with the engaging surface 26 of the protruded portion 22. On the inner surface to which the engaging protrusion 57 is not formed, a guide groove 58 is formed to guide the guide rib 28 of the protruded portion 22.

In this embodiment, initially, the engaging portion 71 of the band 70 of the grommet 50a is inserted into the elongated hole 14 of the pin member 20 and then rotated to slidably attach the engaging portion 71 to the elongated hole 14 of the pin member 20.

By inserting the protruded portion 22 of the pin member 20 into the tubular portion 51a of the grommet 50a, the head portion 25 gradually protrudes outside the tubular portion 51a while outwardly bending the engaging portions 57 and 57 of the tubular portion 51a. When the head portion 25 goes outside the tubular portion 51, as shown in FIG. 10, the engaging portion 57 is engaged with the engaging surface 26 of the protruded portion 22, whereby the pin member 20 is attached to the grommet 50a.

With this embodiment, since the pin member 20 is attached to the interior member 1 via the frame 21, as compared to the first embodiment, the step of attaching the pin member 30 to the mounting seat 10 can be omitted, thereby improving the attaching workability.

The present invention can be used as a connecting structure for connecting, for example, an automotive interior member such as a cover member for covering an automobile air bag and an automotive body panel.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

We claim:

1. A connecting structure for connecting an automotive interior member and an automotive body panel, comprising:
a grommet to be inserted in and engaged with a mounting hole of the automotive body panel;
a pin member to be detachably attached to a mounting seat formed on the interior member, the pin member being configured to be inserted in and engaged with the grommet; and
a band for connecting the grommet and the mounting seat,
wherein the band is connected to the grommet at one end thereof and provided with an engaging portion at the other end thereof, the engaging portion being configured to be slidably engaged with an elongated hole formed in the mounting seat,
wherein an engaging force between the mounting hole of the automotive body panel and the grommet is set to be greater than an engaging force between the grommet and the pin member.

2. The connecting structure of claim 1, wherein the engaging portion provided at the other end of the band has a columnar portion to be inserted in the elongated hole of the mounting seat, and wherein an inner periphery of an end portion of the elongated hole with which the columnar portion comes into contact at the time of the engagement is formed into an arc-shape.

3. The connecting structure of claim 1, wherein, in a state in which the interior member is connected to the automotive body panel, an engaging portion between the mounting hole of the automotive body panel and the grommet and an engaging portion between the grommet and the pin member are positioned at a rear side of the automotive body panel.

4. The connecting structure of claim 2, wherein, in a state in which the interior member is connected to the automotive body panel, an engaging portion between the mounting hole of the automotive body panel and the grommet and an engaging portion between the grommet and the pin member are positioned at a rear side of the automotive body panel.

5. The connecting structure of claim 1, wherein the elongated hole of the mounting seat extends in a direction perpendicular to the interior member, whereby the engaging portion of the band is slidably engaged with the elongated hole of the mounting seat.

6. The connecting structure of claim 5, wherein the engaging portion of the band includes a base plate, an engaging plate disposed apart from the base plate at a certain distance, and the columnar portion connecting the base plate and the engaging plate, the columnar portion positioned in the elongated hole of the mounting seat, and wherein a length of the elongated hole is longer than a length of the engaging plate and a width of the elongated hole is wider than a width of the engaging plate.

7. The connecting structure of claim 1, wherein the pin member includes a basal portion of a generally U-shape to be inserted in and held to the mounting seat in an engaged manner, a protruded portion vertically protruded from one surface of the basal portion, and a shaft portion connecting opposed inner surfaces of the basal portion, and wherein the mounting seat has a mounting wall with an insertion slit and an engaging hole at an end of the slit, whereby the shaft portion of the pin member is slidably inserted in the slit to be positioned in the engaging hole.

8. The connecting structure of claim 7, wherein the pin member further includes elastic wings extending from both sides of the basal portion, wherein the mounting seat is provided with a pair of ribs on the mounting wall and a pair of protrusions apart from the pair of ribs at a certain distance on the mounting wall, and wherein the elastic wings are positioned by the ribs and the protrusions when the pin member is attached to the mounting seat.

9. The connecting structure of claim 7, wherein the grommet has a tubular portion into which the protruded portion of the pin member is to be inserted, and the tubular portion has an engaging hole to be engaged with an engaging protrusion formed on the protruded portion of the pin member and an elastic engaging portion to be engaged with the mounting hole of the automotive body panel.

10. A connecting structure for connecting an automotive interior member and an automotive body panel, comprising:
a grommet to be inserted in and engaged with a mounting hole of the automotive body panel;
a pin member integrally attached to a mounting seat formed on the interior member, the pin member being configured to be inserted in and engaged with the grommet; and
a band for connecting the grommet and the mounting seat,
wherein the band is connected to the grommet at one end thereof and provided with an engaging portion at the other end thereof, the engaging portion being configured to be slidably engaged with an elongated hole formed in the mounting seat, and
wherein an engaging force between the mounting hole of the automotive body panel and the grommet is set to be greater than an engaging force between the grommet and the pin member.

11. The connecting structure of claim 10, wherein the engaging portion provided at the other end of the band has a columnar portion to be inserted in the elongated hole of the mounting seat, and wherein an inner periphery of an end portion of the elongated hole with which the columnar portion comes into contact at the time of the engagement is formed into an arc-shape.

12. The connecting structure of claim 10, wherein, in a state in which the interior member is connected to the automotive body panel, an engaging portion between the mounting hole of the automotive body panel and the grommet and an engaging portion between the grommet and the pin member are positioned at a rear side of the automotive body panel.

13. The connecting structure of claim 11, wherein, in a state in which the interior member is connected to the automotive body panel, an engaging portion between the mounting hole of the automotive body panel and the grommet and an engaging portion between the grommet and the pin member are positioned at a rear side of the automotive body panel.

14. The connecting structure of claim 10, wherein the elongated hole of the mounting seat extends in a direction perpendicular to the interior member, whereby the engaging portion of the band is slidably engaged with the elongated hole of the mounting seat.

15. The connecting structure of claim 14, wherein the engaging portion of the band includes a base plate, an engaging plate disposed apart from the base plate at a certain distance, and the columnar portion connecting the base plate and the engaging plate, the columnar portion being to be positioned in the elongated hole of the mounting seat, and wherein a length of the elongated hole is set to be longer than a length of the engaging plate and a width of the elongated hole is set to be wider than a width of the engaging plate.
